(19) United States
(12) Patent Application Publication
(10) Pub. No.: US 2024/0288892 A1
(43) Pub. Date: Aug. 29, 2024

(54) TECHNIQUE TO REDUCE VOLTAGE REGULATOR OUTPUT NOISE IN PHASE MODULATED HIGH SPEED INTERFACE

(71) Applicant: Meta Platforms Technologies, LLC, Menlo Park, CA (US)

(72) Inventors: Sri Harsha MANJUNATH, Folsom, CA (US); Masum HOSSAIN, Ottawa (CA)

(21) Appl. No.: 18/116,205

(22) Filed: Mar. 1, 2023

(51) Int. Cl. G05F 1/575

(52) U.S. Cl. CPC G05F 1/575

(57) ABSTRACT

A low dropout (LDO) voltage regulator for a transmitter driver includes a set of one or more pass transistors between a voltage input and a voltage output of the LDO voltage regulator, and a control circuit configured to receive data to be transmitted by the transmitter driver and generate control signals to gates of the set of one or more pass transistors based on the data to be transmitted by the transmitter driver.

### BACKGROUND

Voltage regulators are commonly used in electrical circuits to supply regulated supply voltage signals at relatively stable voltage levels to drive the electrical circuits. In high speed circuits, the load current may change rapidly due to the switching of the circuits (e.g., transistors) at high speed. The power supply, voltage regulators, and the power distribution system (including, e.g., traces, vias, or planes) of a high speed circuit may have limited bandwidth (e.g., due to high inductance), and thus may not be able to respond fast enough to deliver the desired amount of current and power instantaneously. As such, the output voltage of the voltage regulator may sag (e.g., due to large IR drop) when the load current increases suddenly, or may spike when the load current reduces suddenly. Therefore, the high di/dt of the load circuits (e.g., a driver of a high-speed data transmitter) may cause the output voltage of the voltage regulator to have high peak-to-peak (P-P) voltage noise.

Nosie on the voltage signal supplied to the load circuits may result in various signal integrity issues, such as jitters (which may reduce the time margin) due to variations in the switch time of transistors caused by the variations in the supply voltage, and noise in the voltage level of the transmitted data bits (which may reduce the voltage margin). As such, the bit error rate of the circuits may increase or the speed of the circuits may need to be reduced to provide enough time and/or voltage margin for reliable data transmission. To improve the power integrity and signal integrity, bypass or decoupling capacitors may need to be positioned close to the load circuits to provide instantaneous current to the load circuits. When di/dt is high, large bypass capacitors close to the load circuit may be needed. The large bypass capacitors may use a large circuit area and may significantly increase the size of the chip, which may result in other issues such as higher cost and lower yield.

### SUMMARY

This disclosure relates generally to voltage regulation in high speed circuits. More specifically, and without limitation, techniques disclosed herein relate to reducing output noise of voltage regulators for high speed interface, such as phase-modulated high speed data transmitters. Various inventive embodiments are described herein, including devices, circuit, systems, methods, structures, processes, and the like.

According to certain embodiments, a low dropout (LDO) voltage regulator for a transmitter driver may include a set of one or more pass transistors between a voltage input and a voltage output of the LDO voltage regulator, and a control circuit configured to receive data to be transmitted by the transmitter driver and generate control signals to gates of the set of one or more pass transistors based on the data to be transmitted by the transmitter driver.

In some embodiments of the LDO voltage regulator, the transmitter driver may include a differential signal driver. The data to be transmitted by the transmitter driver may include data to be transmitted by a first end of the different signal driver and data to be transmitted by a second end of the different signal driver. The set of one or more pass transistors may include a first pass transistor and a second pass transistor. The control circuit may include a first circuit configured to generate a control signal to a gate of the first pass transistor based on the data to be transmitted by the first end of the different signal driver, and a second circuit configured to generate a control signal to a gate of the second pass transistor based on the data to be transmitted by the second end of the different signal driver. In some embodiments, the data to be transmitted by the transmitter driver may include a phase modulated data pattern. The data rate of the data to be transmitted by the transmitter driver may be greater than, for example, about 1 Gbps, such as about 10 Gbps or higher.

In some embodiments of the LDO voltage regulator, the set of one or more pass transistors may include one or more p-channel metal-oxide-semiconductor (PMOS) transistors. The control signals may include a delayed and inverted copy of the received data to be transmitted by the transmitter driver. In some embodiments, the LDO voltage regulator may also include a bypass capacitor at the voltage output of the LDO voltage regulator. The capacitance of the bypass capacitor may be equal to or less than, for example, about 100 pF. In some embodiments, the LDO voltage regulator may also include an array of pass transistors between the voltage input and the voltage output of the LDO voltage regulator, a feedback circuit configured to generate a feedback voltage based on an output voltage of the LDO voltage regulator, a comparator configured to generate a counter control signal based on the feedback voltage and a reference voltage signal, and a counter configured to count up or down in response to the counter control signal and output control bits to gates of the array of pass transistors based on a counter value of the counter.

According to certain embodiments, an integrated circuit may include a data transmitter driver, and a low dropout (LDO) voltage regulator for the data transmitter driver. The LDO voltage regulator may include at least one pass transistor between a voltage input and a voltage output of the LDO voltage regulator, and a control circuit configured to receive data to be transmitted by the data transmitter driver and generate control signals to a gate of the at least one pass transistor based on the data to be transmitted by the data transmitter driver.

In some embodiments of the integrated circuit, the at least one pass transistor may include one or more p-channel metal-oxide-semiconductor (PMOS) transistors. In some embodiments, the data transmitter driver may include a differential signal driver, the data to be transmitted by the data transmitter driver may include data to be transmitted by a first end of the different signal driver and data to be transmitted by a second end of the different signal driver, and the at least one pass transistor may include a first pass transistor and a second pass transistor. The control circuit may include a first circuit configured to generate a control signal to a gate of the first pass transistor based on the data to be transmitted by the first end of the different signal driver, and a second circuit configured to generate a control signal to a gate of the second pass transistor based on the data to be transmitted by the second end of the different signal driver.

In some embodiments of the integrated circuit, the control signals may include a delayed and inverted copy of the received data to be transmitted by the data transmitter driver. In some embodiments, the integrated circuit may include a bypass capacitor at the voltage output of the LDO voltage regulator. The capacitance of the bypass capacitor may be equal to or less than, for example, about 100 pF. The data to be transmitted by the data transmitter driver may include a phase modulated data pattern. The data rate of the data to be transmitted by the data transmitter driver may be greater than, for example, about 1 Gbps, such as about 10 Gbps or higher. In some embodiments, the LDO voltage regulator may further include an array of pass transistors between the voltage input and the voltage output of the LDO voltage regulator, a feedback circuit configured to generate a feedback voltage based on an output voltage of the LDO voltage regulator, a comparator configured to generate a counter control signal based on the feedback voltage and a reference voltage signal, and a counter configured to count up or down in response to the counter control signal and output control bits to gates of the array of pass transistors based on a counter value of the counter.

According to certain embodiments, a method of reducing noise of an output voltage of a low dropout (LDO) voltage regulator for a transmitter driver may include receiving data to be transmitted by the transmitter driver; generating, using the data to be transmitted by the transmitter driver, control signals for controlling a set of pass transistors between a voltage input and a voltage output of the LDO voltage regulator; and sending the control signals to gates of the set of pass transistors. In some embodiments, the data to be transmitted by the transmitter driver may include data to be transmitted by a first end of a different signal driver of the transmitter driver and data to be transmitted by a second end of the different signal driver, where generating the control signals may include generating a control signal to a gate of a first pass transistor of the set of pass transistors using the data to be transmitted by the first end of the different signal driver, and generating a control signal to a gate of a second pass transistor of the set of pass transistors using the data to be transmitted by the second end of the different signal driver.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 is a cross-sectional view of an example of a near-eye display according to certain embodiments.

FIG. 5 illustrates an example of an image source assembly in a near-eye system according to certain embodiments.

FIG. 6 is a simplified block diagram of an example of a display controller for a near-eye display system according to certain embodiments.

FIG. 7 illustrates an examples of an analog low dropout (LDO) voltage regulator.

FIG. 8 illustrates an examples of a digital LDO voltage regulator.

FIG. 9 illustrates operations of an example of a digital LDO voltage regulator.

FIG. 10 illustrates output of a digital LDO voltage regulator driving an amplitude-modulation (AM) data transmitter.

FIG. 11 illustrates output of a digital LDO voltage regulator driving a phase-modulation (PM) data transmitter.

FIG. 12 illustrates LDO output noise reduction using phase modulation.

FIG. 13 illustrates examples of peak-to-peak noise of the output voltage of digital LDO regulators with different loop frequencies, different bypass capacitors at the output, and different reference voltage ranges.

FIG. 14 illustrates an example of a digital LDO voltage regulator including additional pass transistors controlled by data to be transmitted by a transmitter driven by the digital LDO voltage regulator according to certain embodiments.

FIG. 15A includes a simplified block diagram of an example of a digital LDO voltage regulator including additional pass transistors controlled by data to be transmitted by a transmitter driven by the digital LDO voltage regulator according to certain embodiments.

FIG. 15B includes a simplified timing diagram of the example of the digital LDO voltage regulator of FIG. 15A according to certain embodiments.

FIG. 16 illustrates an example of LDO output noise reduction using additional pass transistors controlled by digital data to be transmitted by a transmitter driven by a digital LDO regulator according to certain embodiments.

FIG. 17 is a simplified block diagram of an example of an electronic system of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to voltage regulation in high speed circuits. More specifically, and without limitation, techniques disclosed herein relate to reducing output noise of voltage regulators for high speed interface, such as phase-modulated high speed data transmitters. Various inventive embodiments are described herein, including devices, circuits, systems, methods, structures, processes, and the like.

A driver circuit of a high-speed data transmitter, such as a phase modulation (PM) transmitter (Tx), may be driven by a regulated supply voltage generated by a voltage regulator, which may have a limited response speed. Due to the high di/dt of the high-speed drivers (e.g., with data rate greater than about 1 Gbps, greater than about 10 Gbps, or higher), especially when there are more 1s than 0s or more 0s than 1s in the data pattern, the voltage regulator may not respond as fast to maintain a constant output level. Therefore, the output voltage of the voltage regulator may have ripples (e.g., voltage droop and/or overshoot). The high peak-to-peak voltage noise on the voltage signal supplied to the data transmitter may increase the jitter and/or reduce the differential output voltage level of the transmitter output data, which may in turn increase the bit error rate of the data communication.

In a digital low dropout (DLDO) voltage regulator, a controller may detect the deviation of the output voltage from its desired value (e.g., using one or more comparators and reference voltages), and increase or decrease a counter value accordingly, which may be decoded into a plurality of bits to control a plurality of pass transistors (e.g., p-channel metal-oxide-semiconductor (PMOS) transistors) between the input voltage and output voltage of the DLDO regulator. In this way, the DLDO regulator may respond to the voltage change to either increase or decrease the resistance between the voltage input and voltage output of the DLDO regulator by switching on fewer or more pass transistors, thereby keeping the output voltage of the DLDO regulator substantially constant. For example, when the load current increases and the output voltage drops, the controller may detect the voltage drop and increase a counter value, where the counter value may be decoded to turn on more pass transistors to reduce the resistance and increase the current flow from the input voltage to the output voltage to bring the output voltage higher.

Using PM data pattern, rather than amplitude modulated (AM) data pattern, may reduce the peak-to-peak voltage noise, but the voltage noise may still be too high. To reduce the LDO output noise and maintain a constant output voltage, large bypass capacitors close to the load of the LDO regulator (and thus having low inductance/impedance and low response time) may be used to supply the transient current to the load. But the large bypass capacitor may consume a large chip area.

According to certain embodiments disclosed herein, to further reduce the data-dependent peak-to-peak voltage noise of LDO regulator for data transmitter, one or more pass transistors that are controlled by the data to be transmitted by the data transmitter may be added to the LDO regulator, such that the total size or number of pass transistors (and thus the pass resistance/impedance) may be modulated by the data to be transmitted. For example, these additional pass transistors may include two groups of pass transistors controlled by the two single ends of a differential signal that is phase modulated by the data pattern to be transmitted. In this way, the switching of the additional pass transistors may be synchronized with the switching of the load circuits (e.g., driver circuits of the data transmitter), and thus the output voltage noise of the LDO regulator may be reduced without using large capacitors, which may help to reduce the size of bypass capacitors and save silicon area.

The circuits described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

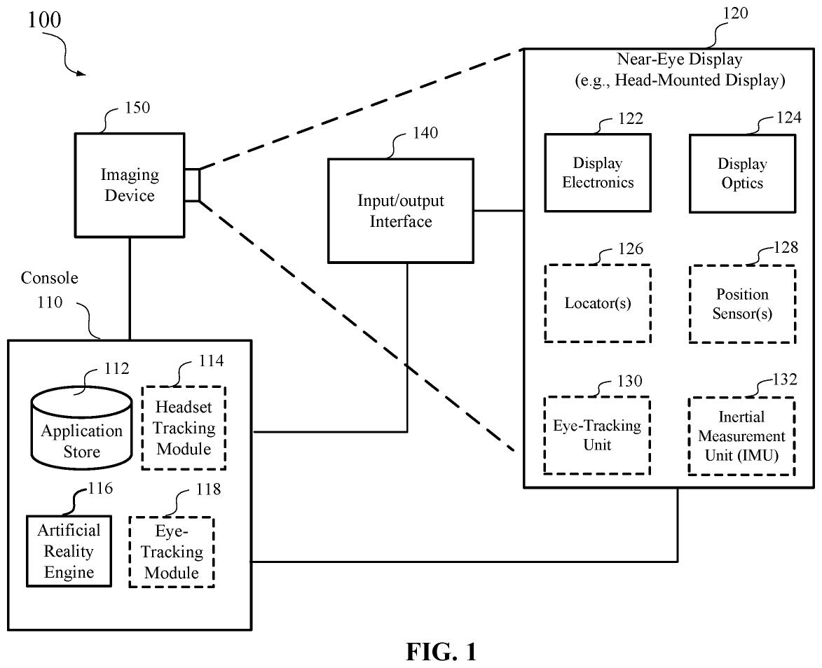

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

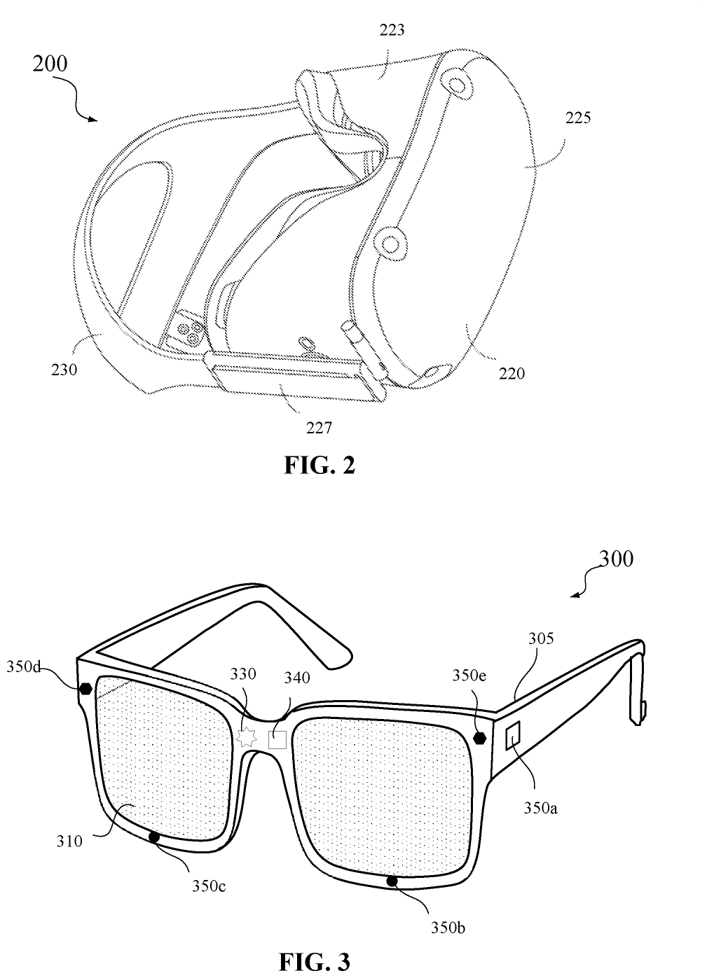

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an anti-reflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be an LED, a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to determine the eye's orientation more accurately.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

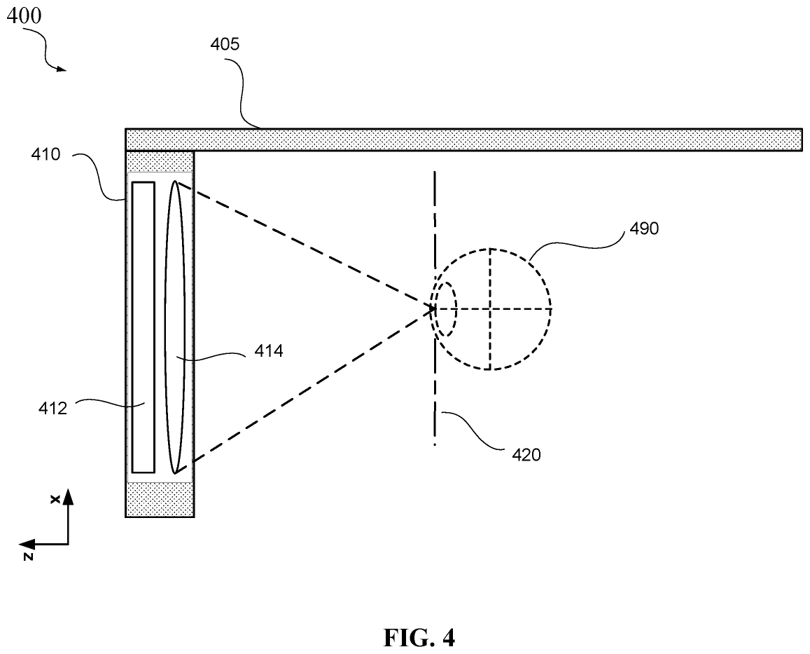

FIG. 4 is a cross-sectional view of an example of a near-eye display 400 according to certain embodiments. Near-eye display 400 may include at least one display assembly 410. Display assembly 410 may be configured to direct image light (e.g., display light) to an eyebox located at an exit pupil 420 and to user's eye 490. It is noted that, even though FIG. 4 and other figures in the present disclosure show an eye of a user of the near-eye display for illustration purposes, the eye of the user is not a part of the corresponding near-eye display.

As HMD device 200 and near-eye display 300, near-eye display 400 may include a frame 405 and display assembly 410 that may include a display 412 and/or display optics 414 coupled to or embedded in frame 405. As described above, display 412 may display images to the user electrically (e.g., using LCDs, LEDs, OLEDs) or optically (e.g., using a waveguide display and optical couplers) according to data received from a processing unit, such as console 110. In some embodiments, display 412 may include a display panel that includes pixels made of LCDs, LEDs, OLEDs, and the like. Display 412 may include sub-pixels to emit light of a predominant color, such as red, green, blue, white, or yellow. In some embodiments, display assembly 410 may include a stack of one or more waveguide displays including, but not restricted to, a stacked waveguide display, a varifocal waveguide display, and the like. The stacked waveguide display may be a polychromatic display (e.g., a red-green-blue (RGB) display) created by stacking waveguide displays whose respective monochromatic sources are of different colors.

Display optics 414 may be similar to display optics 124 and may display image content optically (e.g., using optical waveguides and optical couplers), correct optical errors associated with the image light, combine images of virtual objects and real objects, and present the corrected image light to exit pupil 420 of near-eye display 400, where the user's eye 490 may be located. In some embodiments, display optics 414 may also relay the images to create virtual images that appear to be away from display 412 and further than just a few centimeters away from the eyes of the user. For example, display optics 414 may collimate the image source to create a virtual image that may appear to be far away (e.g., greater than about 0.3 m, such as about 0.5 m, 1 m, or 3 m away) and convert spatial information of the displayed virtual objects into angular information. In some embodiments, display optics 414 may also magnify the source image to make the image appear larger than the actual size of the source image. More details of display 412 and display optics 414 are described below.

In various implementations, the optical system of a near-eye display, such as an HMD, may be pupil-forming or non-pupil-forming. Non-pupil-forming HMDs may not use intermediary optics to relay the displayed image, and thus the user's pupils may serve as the pupils of the HMD. Such non-pupil-forming displays may be variations of a magnifier (sometimes referred to as “simple eyepiece”), which may magnify a displayed image to form a virtual image at a greater distance from the eye. The non-pupil-forming display may use fewer optical elements. Pupil-forming HMDs may use optics similar to, for example, optics of a compound microscope or telescope, and may include some forms of projection optics that magnify an image and relay it to the exit pupil.

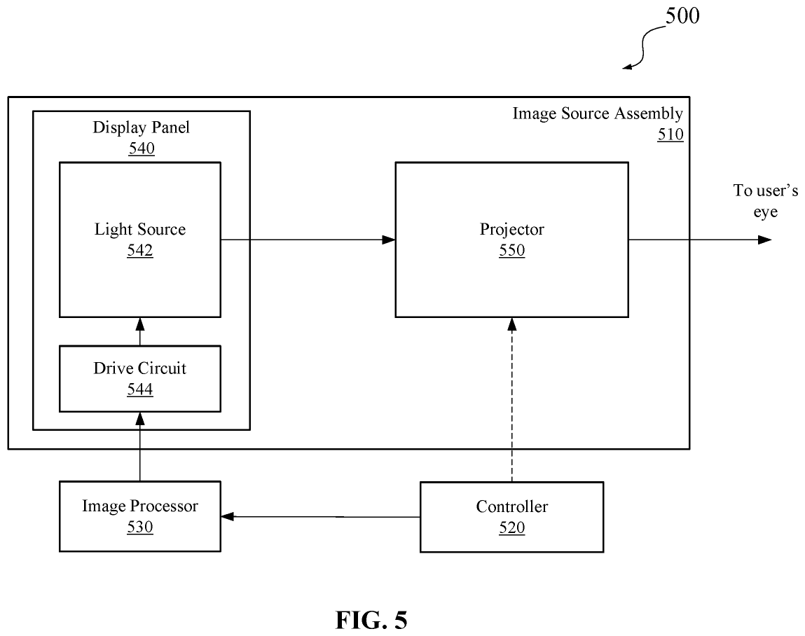

FIG. 5 illustrates an example of an image source assembly 510 in a near-eye display system 500 according to certain embodiments. Image source assembly 510 may include, for example, a display panel 540 that may generate display images to be projected to a user's eyes, and a projector 550 that may project the display images generated by display panel 540 to the user's eye. Display panel 540 may include a light source 542 and a drive circuit 544 for controlling light source 542. Light source 542 may include, for example, LEDs, OLEDs, micro-LEDs, resonant cavity light emitting diodes (RC-LEDs), or other light emitters. Projector 550 may include, for example, a diffractive optical element, a freeform optical element, a scanning mirror, and/or other display optics, such as display optics 414 described above. In some embodiments, near-eye display system 500 may also include a controller 520 that synchronously controls light source 542 and projector 550 (e.g., including a scanner). Image source assembly 510 may generate and output an image to user's eyes.

Light source 542 may include a plurality of light emitters arranged in an array or a matrix. Each light emitter may emit monochromatic light, such as red light, blue light, green light, infra-red light, and the like. While RGB colors are often used, embodiments described herein are not limited to using red, green, and blue as primary colors. Other colors can also be used as the primary colors of near-eye display system 500. In some embodiments, a display panel in accordance with an embodiment may use more than three primary colors. Each pixel in light source 542 may include three subpixels that include a red LED, a green LED, and a blue LED. A semiconductor LED generally includes an active light emitting layer within multiple layers of semiconductor materials. The multiple layers of semiconductor materials may include different compound materials or a same base material with different dopants and/or different doping densities. For example, the multiple layers of semiconductor materials may include an n-type material layer, an active region that may include hetero-structures (e.g., one or more quantum wells), and a p-type material layer.

Controller 520 may control the image rendering operations of image source assembly 510, such as the operations of light source 542 and/or projector 550. For example, controller 520 may determine instructions for image source assembly 510 to render one or more display images. The instructions may include display instructions and/or scanning instructions. In some embodiments, the display instructions may include an image file (e.g., a bitmap file). The display instructions may be received from, for example, a console, such as console 110 described above with respect to FIG. 1. Controller 520 may include a combination of hardware, software, and/or firmware not shown here so as not to obscure other aspects of the present disclosure. In some embodiments, controller 520 may be a graphics processing unit (GPU) of a display device. In other embodiments, controller 520 may be other types of processors.

Image processor 530 may be a general-purpose processor and/or one or more application-specific circuits (e.g., data processing units (DPUs)) that are dedicated to performing the features described herein. In one example, a general-purpose processor may be coupled to a memory to execute software instructions that cause the processor to perform certain processes described herein. In another embodiment, image processor 530 may be one or more circuits that are dedicated to performing certain features. While image processor 530 in FIG. 5 is shown as a stand-alone unit that is separate from controller 520 and drive circuit 544, image processor 530 may be a sub-unit of controller 520 or drive circuit 544 in other embodiments. In other words, in those embodiments, controller 520 or drive circuit 544 may perform various image processing functions of image processor 530. Image processor 530 may also be referred to as an image processing circuit. In some embodiments, the links between image processor 530 and controller 520 may be high-speed serial links. In some embodiments, the links between image processor 530 and drive circuit 544 may be high-speed serial links.

In the example shown in FIG. 5, light source 542 may be driven by drive circuit 544, based on data or instructions (e.g., display and scanning instructions) sent from controller 520 or image processor 530. In one embodiment, drive circuit 544 may include a circuit panel that connects to and mechanically holds various light emitters of light source 542. Light source 542 may emit light in accordance with one or more illumination parameters that are set by the controller 520 and potentially adjusted by image processor 530 and drive circuit 544. The illumination parameters may be used by light source 542 to generate light. The illumination parameters may include, for example, source wavelength, pulse rate, pulse amplitude, beam type (continuous or pulsed), other parameter(s) that may affect the emitted light, or any combination thereof. In some embodiments, the source light generated by light source 542 may include multiple beams of red light, green light, and blue light, or any combination thereof.

Projector 550 may perform a set of optical functions, such as focusing, combining, conditioning, or scanning the image light generated by light source 542. In some embodiments, projector 550 may include a combining assembly, a light conditioning assembly, or a scanning mirror assembly. Projector 550 may include one or more optical components that optically adjust and potentially re-direct the light from light source 542. One example of the adjustment of light may include conditioning the light, such as expanding, collimating, correcting for one or more optical errors (e.g., field curvature, chromatic aberration, etc.), some other adjustments of the light, or any combination thereof. The optical components of projector 550 may include, for example, lenses, mirrors, apertures, gratings, polarizers, waveplates, prisms, or any combination thereof.

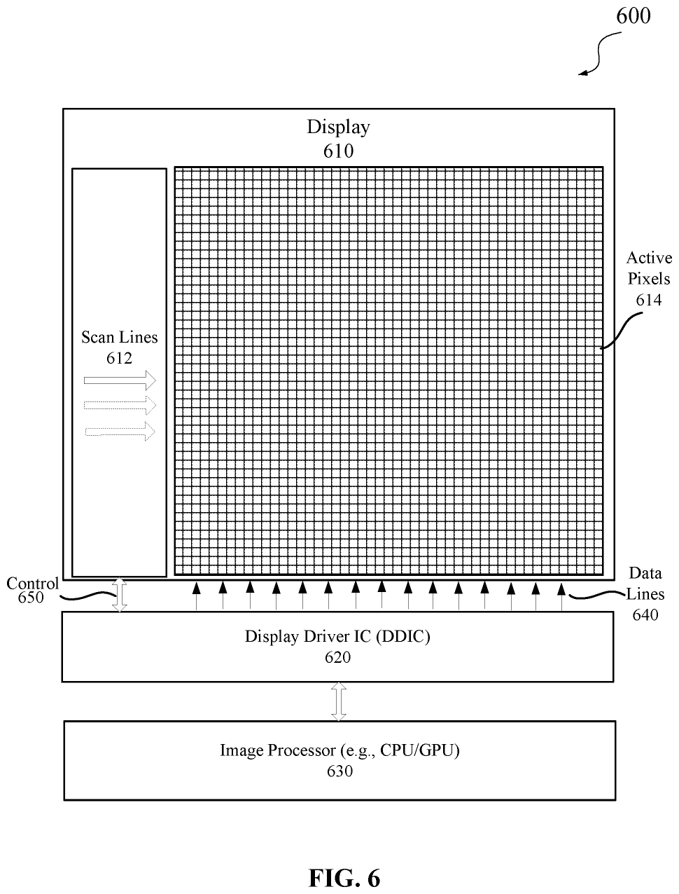

FIG. 6 is a simplified block diagram illustrating an example of a display system 600 including a display 610 according to certain embodiments. Display 610 may be any display panel described above, such as an LCD display, an OLED display, or a micro-LED display. In the illustrated example, display 610 may include active pixels 614 that are arranged in a two-dimensional pixel array. Each active pixel 614 may include three (red, green, and blue) subpixels, such as OLEDs or micro-LEDs. Each active pixel 614 may also include a driving and compensation circuit for each light source. The driving and compensation circuit may receive and store image data for the active pixel and provide a drive current to the light source for light emission.

The two-dimensional pixel array of active pixels 614 may be coupled to a plurality of scan lines 612 and a plurality of data lines 640 directly or indirectly. Each scan line 612 may be coupled to active pixels 614 on a row of the two-dimensional pixel array and may be used to connect active pixels 614 on a row of the two-dimensional pixel array to corresponding data lines 640. Each data line 640 may be coupled to active pixels 614 on a column of the two-dimensional pixel array through switches controlled by scan lines 612. Each data line 640 may be used to send image data to the active pixel 614 coupled to a scan line 612 that has been selected or activated. In general, the plurality of scan lines may be selected or activated one at a time to sequentially connect the active pixels coupled to the scan lines to corresponding data lines. The plurality of data lines 640 may be driven in parallel to send data to a row of active pixels 614 connected to a selected or activated scan line 612 at the same time.

Display 610 may also include some on-panel peripheral circuits, such an array of gates used to drive different scan lines for selecting pixels on the scan lines to receive image data for displaying. The peripheral circuits may be connected to a control bus 650, which may send control signal(s) to selectively activate (scan) the plurality of scan lines for receiving image data and turning on the light sources for light emission.

Data lines 640 and control bus 650 may be driven by a display driver IC (DDIC) 620. DDIC 620 may receive image data from an image processor 630 and send the received image data to active pixels 614 through data lines 640. In some implementations, DDIC 620 may not include a buffer. In some implementations, DDIC 620 may include a frame buffer, and thus may temporarily store the received image data and process the image data before sending the image data to data lines 640. For example, in some implementations, DDIC 620 may perform scaling, scrambling, distortion, correction, or other transformation of the image data. DDIC 620 may also generate scan control signals, such as clocks and various trigger signals, and send the scan control signals to display 610 through control bus 650.

Image processor 630 may include one or more CPUs, GPUs, or DPUs. Image processor 630 may receive information such as position information, acceleration information, velocity information, predicted future positions, or some combination thereof (e.g., from various sensors), and execute graphic processing applications (e.g., a game) to render image frames using the received information. In some embodiments, image data generated by image processor 630 may be sent to DDIC 620 through a high-speed serial link.

The display circuits described above, including the high-speed serial links between an image processor and the DDIC, need to operate at certain voltage levels. Supply voltages with the desired levels may be provided by voltage regulators or other power management circuits. For example, the driver of a high-speed data transmitter may be driven by a regulated supply voltage generated by a voltage regulator, such as a low dropout (LDO) voltage regulator. A voltage regulator may have a limited response speed. Due to high di/dt of the high-speed drivers (e.g., with data rate greater than about 1 Gbps, greater than about 10 Gbps, or higher), especially when there are more 1s than 0s or more 0s than 1s in the data pattern, the voltage regulator may not respond as fast to maintain a constant output level. Therefore, the output voltage of the voltage regulator may have ripples (e.g., voltage droop and/or overshoot). The high peak-to-peak voltage noise on the voltages signal supplied to the data transmitter driver may increase the jitter and/or reduce the differential output voltage level of the transmitter output data, which may in turn increase the bit error rate of the data communication.

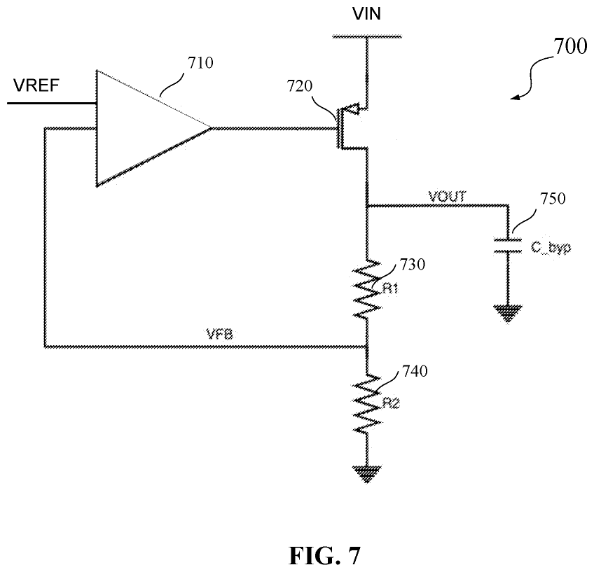

FIG. 7 illustrates an examples of an analog LDO voltage regulator 700. An LDO regulator may generally regulate an output voltage from a higher input voltage. An LDO regulator may include a variable resistor (which may be implemented using, for example, transistors such as PMOS transistors) and a controller that adjusts the resistance of the variable resistor and thus the voltage drop from the input voltage to the output voltage of the LDO regulator. The controller may adjust the resistance of the variable resistor based on a feedback from the output voltage to keep the output voltage approximately constant, even with variable input voltage and/or variable load current. For example, if the load current increases and the output voltage drops, the controller may decrease the resistance of the variable resistor to reduce the IR drop and increase the current flow from the input through the variable resistor to the output of the LDO regulator. If the load current decreases and the output voltage increases, the controller may increase the resistance of the variable resistor to increase the IR drop and decrease the current flow from the input through the variable resistor to the output of the LDO regulator.

In the example illustrated in FIG. 7, analog LDO voltage regulator 700 may include a comparator 710 (e.g., a differential amplifier), a PMOS transistor 720, a voltage divider including a first resistor 730 (R1) and second resistor 740 (R2). PMOS transistor 720 may be between an input voltage VIN and the output of analog LDO voltage regulator 700. Output level Vour may be fed back to comparator 710 and compared with a reference voltage VREF. The output of comparator 710 may drive the gate of PMOS transistor 720 to change the resistance between the drain and source of PMOS transistor 720, such that the output voltage Vour of analog LDO voltage regulator 700 may be approximately VOUT=VREF×(1+R1/R2). A bypass capacitor 750 may be add at the output of analog LDO voltage regulator 700 to provide additional bypass current when the output voltage of analog LDO voltage regulator 700 changes.

In a digital low dropout (DLDO) regulator, a controller may detect the deviation of the output voltage from its desired value (e.g., using one or more comparators), and increase or decrease a counter value, which may be decoded into a plurality of bits to control a plurality of pass transistors (e.g., PMOS transistors) between the voltage input and voltage output of the DLDO. In this way, the DLDO may respond to the voltage change to either increase or decrease the resistance between the voltage input and voltage output by switching on fewer or more pass transistors, thereby keeping the output voltage approximately constant. For example, when the load current increases and the output voltage drops, the controller may detect the voltage change and increase (or decrease in some implementations) a counter value, where the counter value may be decoded to turn on more pass transistors to reduce the resistance and increase the current flow from the voltage input to the voltage output.

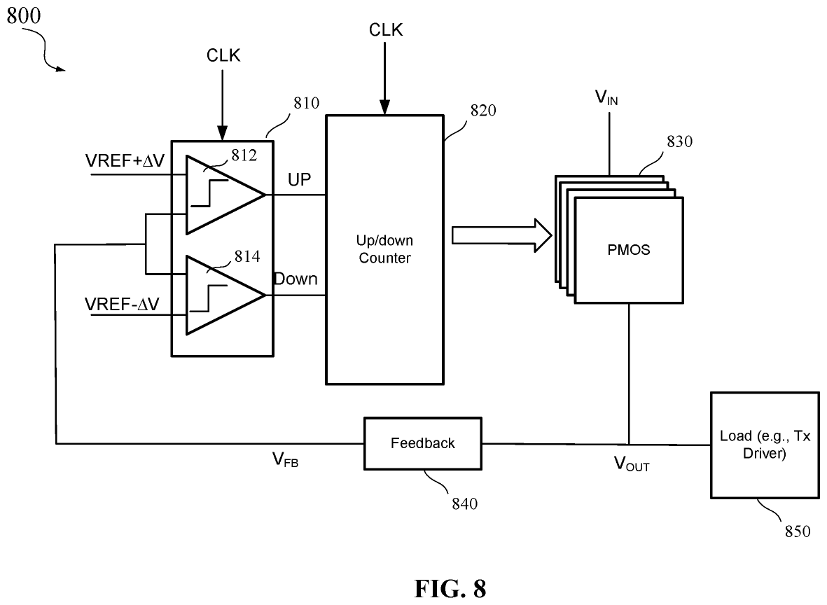

FIG. 8 includes a block diagram of an examples of a digital LDO voltage regulator 800 that drives a load 850, such as a differential driver of a data transmitter. Digital LDO voltage regulator 800 shown in FIG. 8 includes a comparator block 810, an up/down counter 820, an array of PMOS transistors 830, and a feedback block 840. Feedback block 840 may provide a feedback voltage V_{FB} that may be a function (e.g., a ratio determined by a voltage divider as shown in FIG. 7) of the output voltage Vour of digital LDO voltage regulator 800 to comparator block 810. Comparator block 810 may include a comparator 812 and a comparator 814. Up/down counter 820 may count up or down based on outputs of comparator block 810, and may decode the counter value into a plurality of bits (e.g., 256 bits) to control the array of PMOS transistors 830.

In one example, comparator 812 may compare the feedback voltage V_{FB} and a reference voltage VREF+ΔV, and, for example, generate an upward counting signal when the feedback voltage V_{FB} is greater than the reference voltage or generate a low output when the feedback voltage V_{FB} is lower than the reference voltage. Comparator 814 may compare the feedback voltage V_{FB} and a reference voltage VREF-AV, and, for example, generate a downward counting signal when the feedback voltage V_{FB} is lower than the reference voltage or generate a low output when the feedback voltage V_{FB} is greater than the reference voltage. Thus, when the feedback voltage V_{FB} is lower than VREF−ΔV, the upward counting signal may be low and downward counting signal may be high, and thus up/down counter 820 may count down, such that more bits in the outputs of up/down counter 820 may be at the low level to turn on more PMOS transistors 830, thereby reducing the resistance between VIN and Vour and increasing Vour. When the feedback voltage V_{FB} is higher than VREF+ΔV, the upward counting signal may be high and downward counting signal may be low, and thus up/down counter 820 may count up, such that more bits in the outputs of up/down counter 820 may be at the high level to turn off more PMOS transistors 830, thereby increasing the resistance between VIN and Vour, and decreasing Vour. When the feedback voltage V_{FB} is between VREF+ΔV and VREF−ΔV, both the upward countering signal and the downward counting signal may be low, such that up/down counter 820 may keep the same outputs. It is noted that, in other implementations, comparators 812 and 814 and up/down counter 820 may be configured differently, for example, to count up when V_{FB} is lower than VREF−ΔV, and count down when V_{FB} is higher than VREF+ΔV, and the outputs of up/down counter 820 may be configured decode the counter value to turn on more PMOS transistors 830 when the counter value increases and turn on fewer PMOS transistors 830 when the counter value decreases.

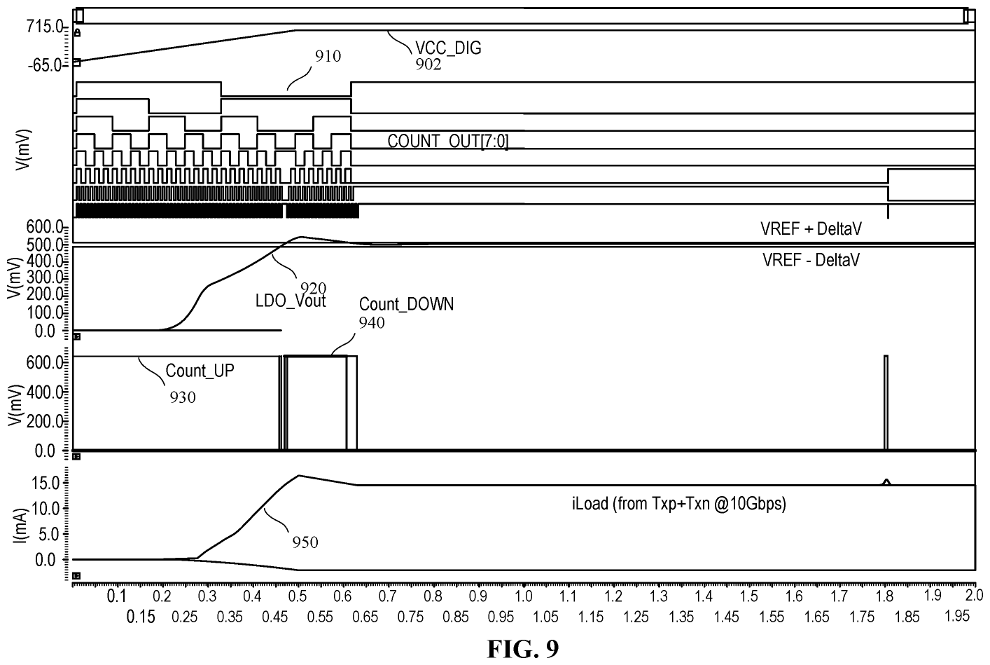

FIG. 9 illustrates operations of an example of a digital LDO regulator, such as digital LDO voltage regulator 800. In FIG. 9, a waveform 902 shows the supply voltage VCC_DIG for a digital circuit, waveforms 910 shows outputs of a counter (e.g., up/down counter 820), a waveform 920 shows the output voltage of the digital LDO regulator, a waveform 930 shows the upward counting signal (Count_Up) from a comparator (e.g., comparator 812), a waveform 940 shows the downward counting signal (Count_Down) from a comparator (e.g., comparator 814), and a waveform 950 shows the load current of the digital LDO regulator (e.g., load current of the driver of a differential signal transmitter).

In the illustrated example, when the digital LDO regulator is started, the load current may increase but the output voltage of the digital LDO regulator may still be low, and thus the upward counting signal (Count_Up) may be high and the downward counting signal (Count_Down) may be low. Therefore, the counter value may increase and more pass transistors (e.g., PMOS transistors) may be turned on to supply current to the load circuit and bring the output voltage of the digital LDO regulator up. When the output voltage of the digital LDO regulator reaches VREF-AV, both the upward counting signal (Count_Up) and the downward counting signal (Count_Down) may be low, and thus the counter value may not change and the number of pass transistors that are turned on may not change. As the output voltage of the digital LDO regulator exceeds VREF+ΔV, the upward counting signal (Count_Up) may be low and the downward counting signal (Count_Down) may be high. Therefore, the counter value may decrease and fewer pass transistors (e.g., PMOS transistors) may be turned on, such that the resistance of the pass transistors may increase and the output voltage of the digital LDO regulator may decrease due to the increased IR drop. As a result, the output voltage of the digital LDO regulator may be maintained at an approximately constant level within VREF-AV and VREF+ΔV.

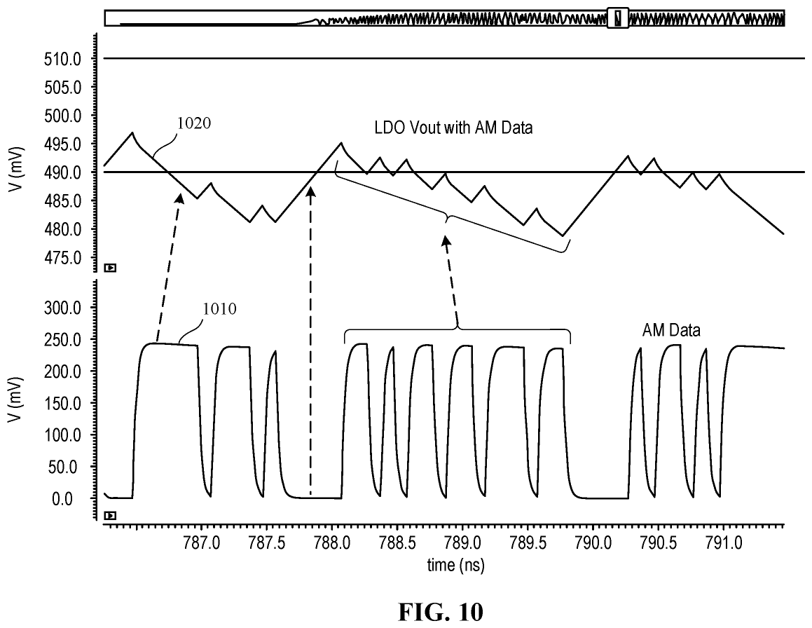

FIG. 10 illustrates an example of the output of a digital LDO voltage regulator driving an amplitude-modulation (AM) data transmitter. In FIG. 10, a waveform 1010 shows the amplitude-modulated output data of the transmitter, and a waveform 1020 shows the output voltage of the digital LDO regulator driving the AM data transmitter. As shown in FIG. 10, when the transmitted data includes consecutive “1s” or consecutive “0s,” the output voltage of the digital LDO regulator may continue to decrease or continue to increase. Therefore, there may large swings or ripples in the output voltage of the digital LDO regulator. In the example shown in FIG. 10, the data may be pseudorandom data, the data format may be not-return-to zero (NRZ), and the peak-to-peak voltage of the ripples in the output of the digital LDO regulator may be greater than about 15 mV.

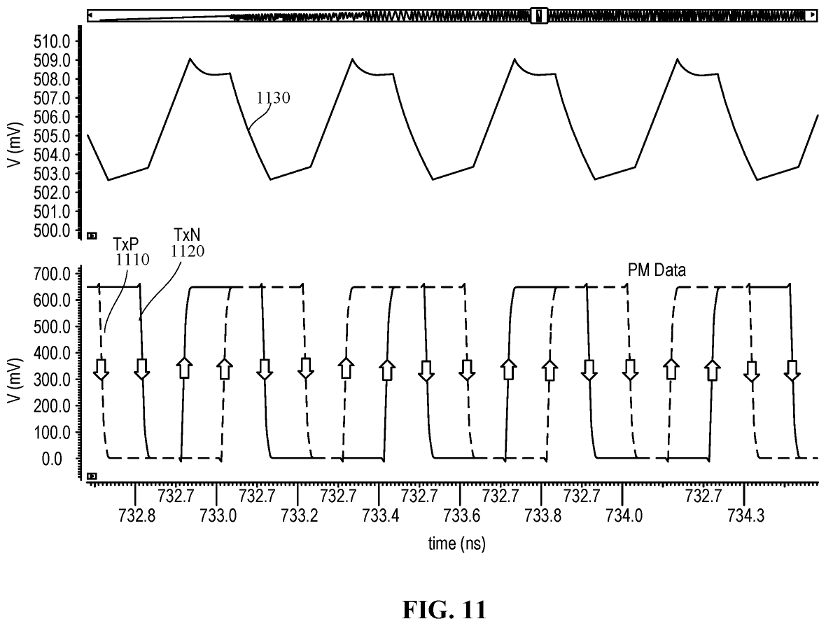

FIG. 11 illustrates an example of the output of a digital LDO voltage regulator driving a phase-modulation (PM) data transmitter. In FIG. 11, a waveform 1110 shows the output of a single end (e.g., TxP output) of the differential output of the PM data transmitter, a waveform 1120 shows the output of another single end (e.g., TxN output) of the differential output of the PM data transmitter, while a waveform 1130 shows the output voltage of the digital LDO regulator driving the PM data transmitter. In the example shown in FIG. 11, the transmitted data may be pseudorandom data, and the peak-to-peak voltage of the ripples in the output of the digital LDO regulator may be greater than about 7 mV. Therefore, using PM data pattern, rather than amplitude modulated data pattern, may reduce the peak-to-peak voltage noise.

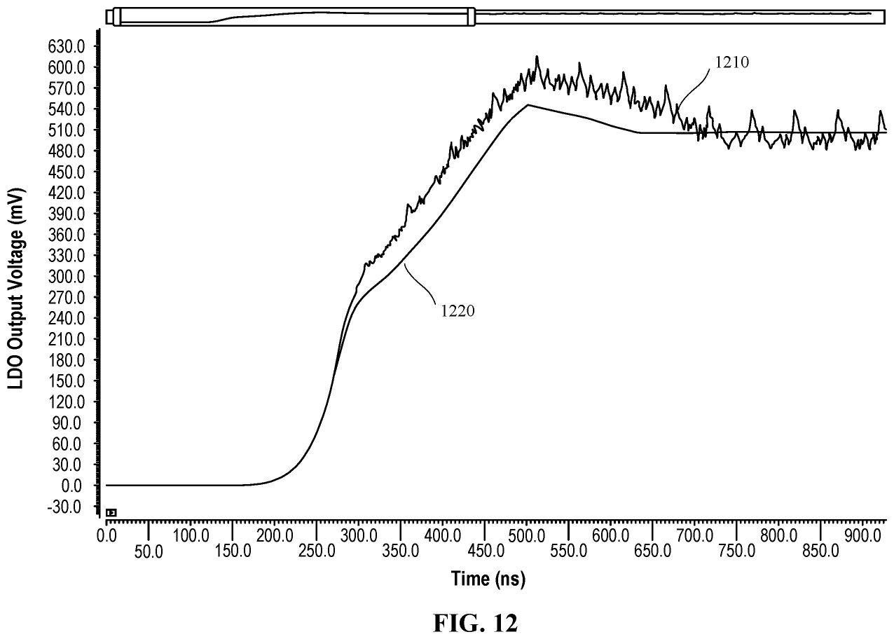

FIG. 12 illustrates LDO output noise reduction using a phase-modulation data transmitter. In FIG. 12, a waveform 1210 shows the output voltage of a digital LDO voltage regulator driving an amplitude-modulation data transmitter, whereas a waveform 1220 shows the output voltage of a digital LDO voltage regulator driving a phase-modulation data transmitter. In the illustrated example, a bypass capacitor about 100 pF is used at the output of the digital LDO voltage regulator, the loop frequency of the digital LDO regulator is about 400 MHZ, VREF (middle voltage of the reference voltages, or the common mode of the differential output signal) is about 500 mV, the ΔV on each VREF signal (or a single-end output of the transmitter) is about 10 mV, and the transmitter may transmit data at a data rate about 10 Gbps. FIG. 12 shows that using PM data pattern, rather than amplitude modulated data pattern, can significantly reduce ripples and the peak-to-peak voltage of the noise in the output voltage of the digital LDO regulator.

To further reduce the LDO output noise and maintain a constant output voltage, large bypass capacitors close to the load of the LDO regulator may be used to supply the transient current to the load. The large bypass capacitors close to the load of the LDO regulator may have low inductance/impedance and low response time, and thus may provide current to the load instantaneously to reduce ripples in the output voltage of the digital LDO regulator. One drawback of using large bypass capacitors to reduce the noise on the output voltage of the digital LDO regulator is that the large bypass capacitor may consume a large chip area, which may increase the size and cost of the chip and reduce the yield.

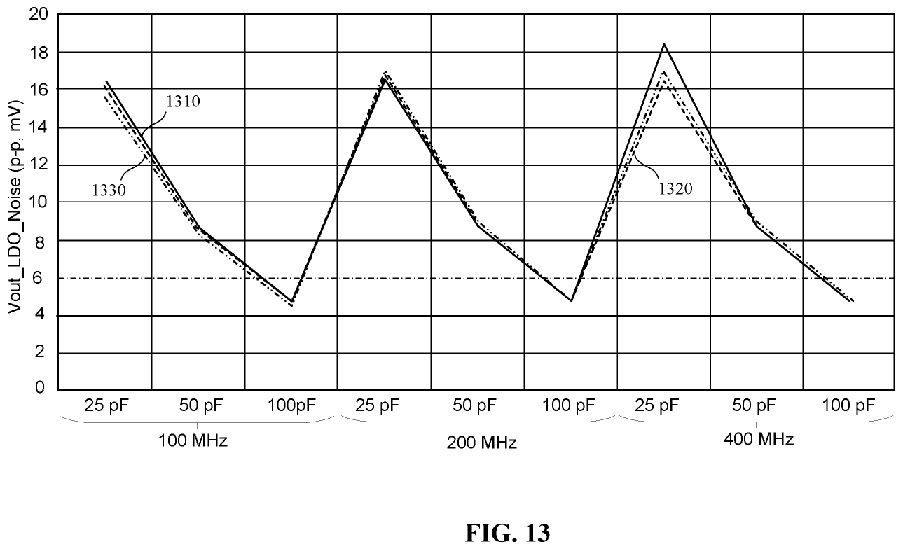

FIG. 13 illustrates examples of peak-to-peak noise of the output voltage of digital LDO regulators with different loop frequencies, different bypass capacitors at the output, and different reference voltage ranges (or differential voltages at the differential output). The values of the bypass capacitors in the examples shown in FIG. 13 include 25 pF, 50 pF, and 100 pF. The loop frequencies used in the examples shown in FIG. 13 include 100 MHZ, 200 MHZ, and 400 MHz. A curve 1310 in FIG. 13 shows the peak-to-peak noise of the output voltage of digital LDO regulators with different loop frequencies and different bypass capacitors at the output, where the ΔV in the reference voltages (or differential outputs) is about 5 mV. A curve 1320 shows the peak-to-peak noise of the output voltage of digital LDO regulators with different loop frequencies and different bypass capacitors at the output, where the ΔV in the reference voltages (or differential outputs) is about 10 mV. A curve 1330 shows the peak-to-peak noise of the output voltage of digital LDO regulators with different loop frequencies and different bypass capacitors at the output, where the ΔV in the reference voltages (or differential outputs) is about 15 mV. FIG. 13 shows that the peak-to-peak noise of the output voltage of digital LDO regulators may only change slightly with the changes in the reference voltage range and/or the loop frequency. However, the peak-to-peak noise of the output voltage of digital LDO regulators may be reduced significantly with the increase of the size of the bypass capacitor. However, as described above, using large bypass capacitors that may consume a large chip area to reduce the noise on the output voltage of the digital LDO regulator may increase the size and cost of the chip and reduce the yield.

According to certain embodiments disclosed herein, to further reduce the data-dependent peak-to-peak voltage noise of LDO regulator for data transmitter, one or more pass transistors that are controlled by the data to be transmitted by the data transmitter may be added to the LDO regulator, such that the total size or number of pass transistors (and thus the pass resistance/impedance) may be modulated by the data to be transmitted. For example, these additional pass transistors may include two groups of pass transistors controlled by the two single ends of a differential signal that is phase modulated by the data pattern to be transmitted. In this way, the switching of the additional pass transistors may be synchronized with the switching of the load circuits (e.g., driver circuits of the data transmitter), and thus the output voltage noise of the LDO regulator may be reduced without using large capacitors, which may help to reduce the size of bypass capacitors and save silicon area.

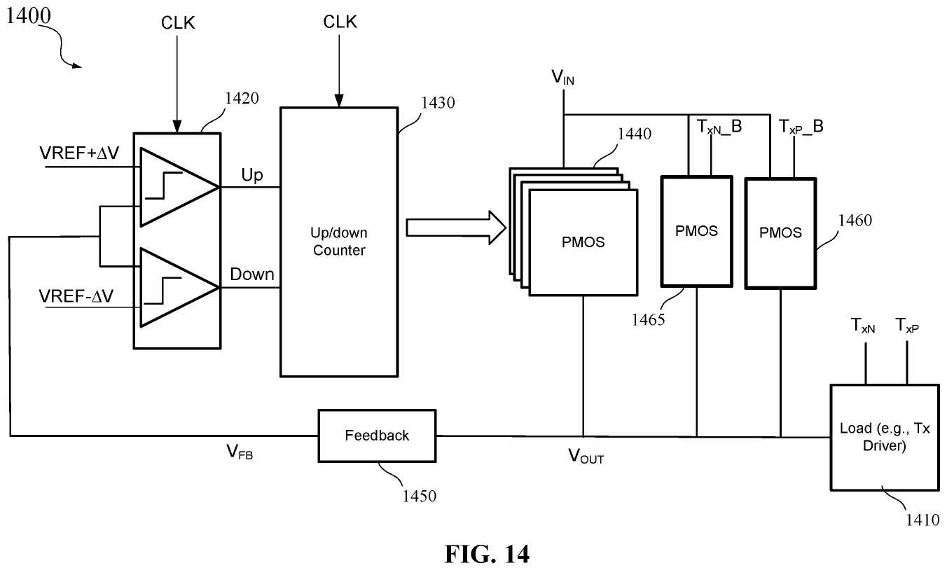

FIG. 14 includes a block diagram of an example of a digital LDO voltage regulator 1400 including additional pass transistors controlled by data to be transmitted by a transmitter driven by digital LDO voltage regulator 1400 according to certain embodiments. Digital LDO voltage regulator 1400 may include a comparator block 1420, an up/down counter 1430, an array of PMOS transistors 1440, and a feedback block 1450, which may be similar to comparator block 810, up/down counter 820, the array of PMOS transistors 830, and feedback block 840 of digital LDO voltage regulator 800, respectively, and thus are not described again in details herein. Digital LDO voltage regulator 1400 may be used to drive a load 1410, which may include, for example, a transmitter driver configured to receive input data T_{xN} and T_{xP} to be transmitted and transmit the digital data as differential signals at a high speed (e.g., greater than about 1 Gbps or higher, such as about 10 Gbps).

Compared with digital LDO voltage regulator 800, digital LDO voltage regulator 1400 may also include additional pass transistors 1460 and 1465 between the input voltage VIN and the output Vour of digital LDO voltage regulator 1400. Pass transistors 1460 and 1465 may be controlled by the complementary signals of the input data T_{xN} and T_{xP}. For example, pass transistors 1460 may be controlled by a signal T_{xP_B}, whereas pass transistors 1465 may be controlled by a signal T_{xN_B}. Pass transistors 1460 may include a plurality of PMOS transistors, where the number of PMOS transistors may be determined based on the drive capability and/or resistance of each PMOS transistor, which may depend on the fabrication process. For example, for PMOS transistors made from a fast process corner, the drive capability of each PMOS transistor may be low and the ON resistance of each PMOS transistor may be high, and thus more PMOS transistors may be used to achieve the desired low resistance. In some embodiments, an additional control signal may be used to switch off some PMOS transistors of a digital LDO voltage regulator 1400 based on the fabrication process corner of the wafer that the digital LDO voltage regulator 1400 is from, so that different numbers of pass transistors 1460 and 1465 may be switched on by the data to be transmitted in digital LDO voltage regulators 1400 made from different fabrication process corner. For example, a digital LDO voltage regulator 1400 made from slow process corner may have fewer pass transistors 1460 or 1465 enable since each PMOS transistor in the slow process corner may have a higher channel width and a lower ON resistance.

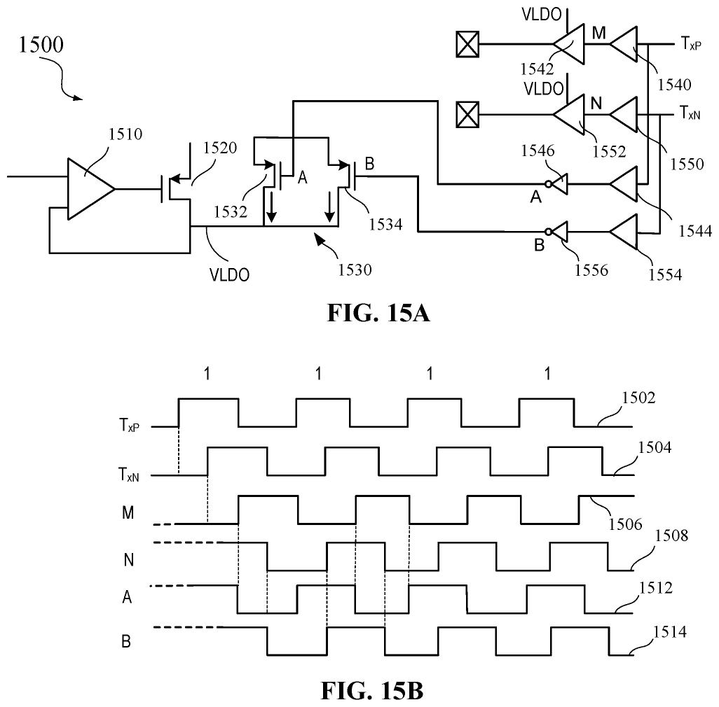

FIG. 15A includes a simplified block diagram of an example of a digital LDO voltage regulator 1500 including a set of pass transistors 1520 controlled by digital control logic 1510 and additional pass transistors 1530 (e.g., PMOS transistors) controlled by data to be transmitted by a transmitter driven by digital LDO voltage regulator 1500 according to certain embodiments. Digital control logic 1510 may include, for example, a comparator block (e.g., comparator block 1420), an up/down counter (e.g., up/down counter 1430), and a feedback block (e.g., feedback block 1450). Digital control logic 1510 may be used to control the set of pass transistors 1520 as described above with respect to FIGS. 8 and 14.

The additional pass transistors 1530 may be controlled by data to be transmitted by the transmitter driven by digital LDO voltage regulator 1500. In the illustrated example, single-ended input data T_{xP} may be received and conditioned by a pre-driver 1540 of the transmitter driver and then send to a single-ended driver 1542 of the transmitter driver for transmitting. The output data of pre-driver 1540 is labeled as “M” in FIG. 15A. Single-ended driver 12 of the transmitter driver may be driven by the output voltage VLDO of digital LDO voltage regulator 1500. Single-ended input data T_{xP} may also be received and conditioned by a pre-driver 1544 and be inverted by an inverter 1546 to control pass transistors 1532 of the transmitter driver. The output data of inverter 1546 is labeled as “A” in FIG. 15A. Thus, when a logic “1” is to be transmitted by single-ended driver 1542, output data “A” may be low and thus one or more pass transistor 1532 may be turned on. When a logic “0” is to be transmitted by the single-ended driver 1542, output data “A” may be high and pass transistor 1532 may be turned off. In this way, pass transistor 1532 may be turned on or off based on the data to be transmitted, to provide additional current for the transmitter driver to transmit the data.

Similarly, single-ended input data T_{xN} may be received and conditioned by a pre-driver 1550 of the transmitter driver and then send to a single-ended driver 1552 of the transmitter driver for transmitting. The output data of pre-driver 1550 is labeled as “N” in FIG. 15A. Single-ended driver 1552 of the transmitter driver may be driven by the output voltage VLDO of digital LDO voltage regulator 1500. Single-ended input data T_{xN} may also be received and conditioned by a pre-driver 1554 and be inverted by an inverter 1556 to control pass transistors 1534 of the transmitter driver. The output data of inverter 1556 is labeled as “B” in FIG. 15A. Thus, when a logic “1” is to be transmitted by single-ended driver 1552, output data “B” may be low and thus one or more pass transistor 1534 may be turned on. When a logic “0” is to be transmitted by single-ended driver 1552, output data “B” may be high and pass transistor 1534 may be turned off. In this way, pass transistor 1534 may be turned on or off based on the data to be transmitted, to provide additional current for the transmitter driver to transmit the data.

FIG. 15B includes a simplified timing diagram of the example of digital LDO voltage regulator 1500 of FIG. 15A according to certain embodiments. In FIG. 15B, a waveform 1502 and a waveform 1504 show examples of data to be transmitted by the P end and the N end of the differential transmitter driver, respectively. A waveform 1506 and a waveform 1508 show examples of output data of the pre-drivers on the P end and the N end of differential transmitter driver, respectively. A waveform 1512 and a waveform 1514 show examples of the output data A and B of the conditioned and inverted data to be transmitted by the P end and the N end of differential transmitter driver, respectively. In the illustrated example, waveform 1506 and waveform 1512 may be complementary to each other and may be aligned to drive the P end of the transmitter driver and pass transistors 1532 at about the same time so that pass transistors 1532 may provide at least a portion of the transient current used by the P end of the transmitter driver. Similarly, waveform 1508 and waveform 1514 may be complementary to each other and may be aligned to drive the N end of the transmitter driver and pass transistors 1534 at about the same time so that pass transistors 1534 may provide at least a portion of the transient current used by the N end of the transmitter driver.

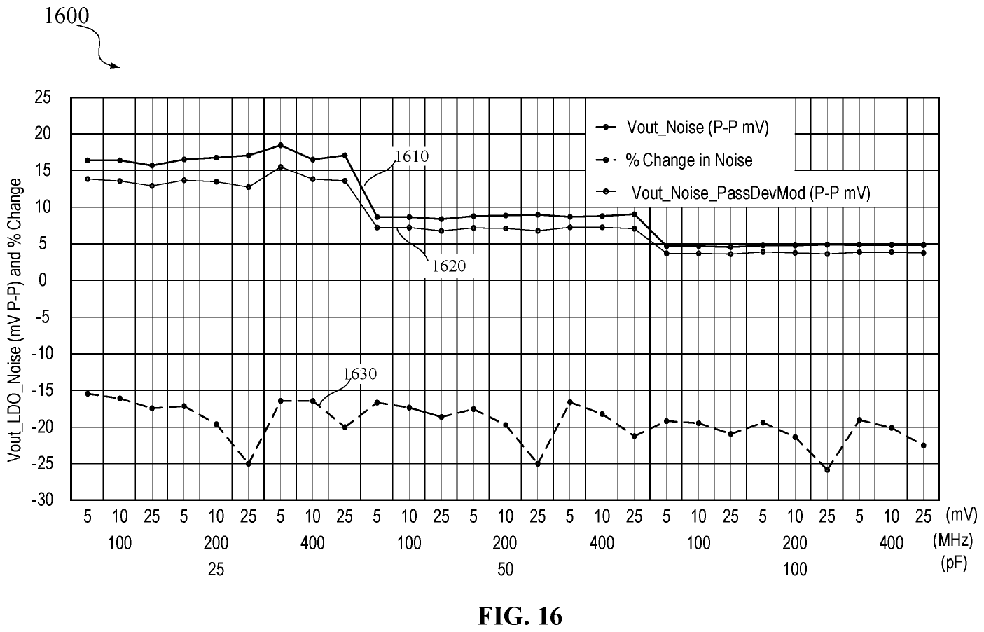

FIG. 16 includes a diagram 1600 illustrating examples of results of using additional pass transistors controlled by digital data to be transmitted by a transmitter driven by a digital LDO regulator according to certain embodiments. A curve 1610 in diagram 1600 shows the peak-to-peak noise of the output voltage of digital LDO regulators (e.g., digital LDO voltage regulator 800) having different loop frequencies, different bypass capacitors at the output, and different reference voltage ranges (or differential voltages ΔV at the differential output). A curve 1620 shows the peak-to-peak noise of the output voltage of digital LDO regulators disclosed herein (e.g., digital LDO voltage regulator 1400 or 1500) having different loop frequencies, different bypass capacitors at the output, and different reference voltage ranges. In the examples shown in FIG. 13, the values of the bypass capacitors include 25 pF, 50 pF, and 100 pF; the loop frequencies used in the examples include 100 MHZ, 200 MHz, and 400 MHz; and differential voltages (ΔV) at the two reference voltages (or the differential output) may be about 5 mV, 10 mV, or 25 mV.

Curves 1610 and 1620 show that varying the differential voltage or the loop frequency may not significantly affect the peak-to-peak noise of the output voltage of digital LDO regulators. Increasing the bypass capacitor value may reduce the peak-to-peak noise of the output voltage of digital LDO regulators. In addition, using additional pass transistors controlled by the digital data to be transmitted may significantly reduce the peak-to-peak noise of the output voltage of digital LDO regulators, as shown by a curve 1630, which indicates the reduction of the peak-to-peak noise of the output voltage of digital LDO regulators by the additional pass transistors controlled by digital data to be transmitted. Curve 1630 shows that the peak-to-peak noise of the output voltage of digital LDO regulators can be reduced by 15% or more using the techniques disclosed herein, compared with existing digital LDO voltage regulators.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

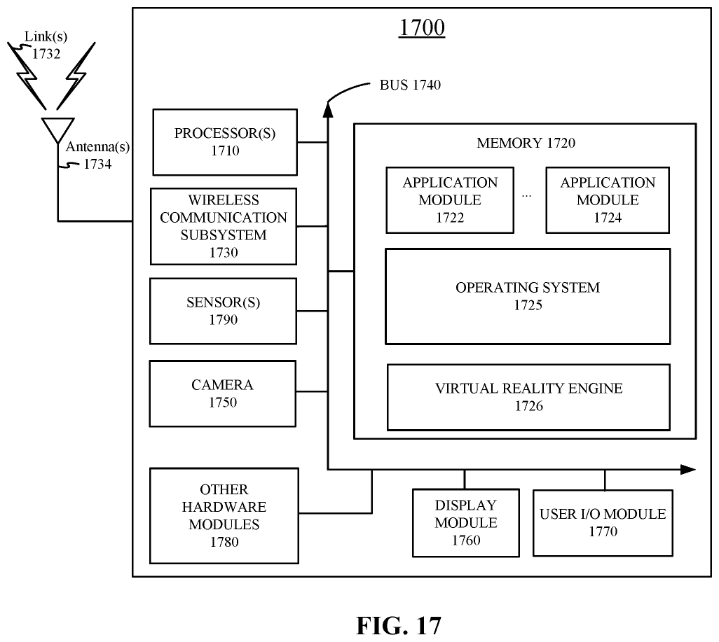

FIG. 17 is a simplified block diagram of an example of an electronic system 1700 of a near-eye display (e.g., HMD device) for implementing some of the examples disclosed herein. Electronic system 1700 may be used as the electronic system of an HMD device or other near-eye displays described above. In this example, electronic system 1700 may include one or more processor(s) 1710 and a memory 1720. Processor(s) 1710 may be configured to execute instructions for performing operations at a number of components, and can be, for example, a general-purpose processor or microprocessor suitable for implementation within a portable electronic device. Processor(s) 1710 may be communicatively coupled with a plurality of components within electronic system 1700. To realize this communicative coupling, processor(s) 1710 may communicate with the other illustrated components across a bus 1740. Bus 1740 may be any subsystem adapted to transfer data within electronic system 1700. Bus 1740 may include a plurality of computer buses and additional circuitry to transfer data.

Memory 1720 may be coupled to processor(s) 1710. In some embodiments, memory 1720 may offer both short-term and long-term storage and may be divided into several units. Memory 1720 may be volatile, such as static random access memory (SRAM) and/or dynamic random access memory (DRAM) and/or non-volatile, such as read-only memory (ROM), flash memory, and the like. Furthermore, memory 1720 may include removable storage devices, such as secure digital (SD) cards. Memory 1720 may provide storage of computer-readable instructions, data structures, program modules, and other data for electronic system 1700.

In some embodiments, memory 1720 may store a plurality of application modules 1722 through 1724, which may include any number of applications. Examples of applications may include gaming applications, conferencing applications, video playback applications, or other suitable applications. The applications may include a depth sensing function or eye tracking function. Application modules 1722-1724 may include particular instructions to be executed by processor(s) 1710. In some embodiments, certain applications or parts of application modules 1722-1724 may be executable by other hardware modules 1780. In certain embodiments, memory 1720 may additionally include secure memory, which may include additional security controls to prevent copying or other unauthorized access to secure information.

In some embodiments, memory 1720 may include an operating system 1725 loaded therein. Operating system 1725 may be operable to initiate the execution of the instructions provided by application modules 1722-1724 and/or manage other hardware modules 1780 as well as interfaces with a wireless communication subsystem 1730 which may include one or more wireless transceivers. Operating system 1725 may be adapted to perform other operations across the components of electronic system 1700 including threading, resource management, data storage control and other similar functionality.

Wireless communication subsystem 1730 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1700 may include one or more antennas 1734 for wireless communication as part of wireless communication subsystem 1730 or as a separate component coupled to any portion of the system. Depending on desired functionality, wireless communication subsystem 1730 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1730 may permit data to be exchanged with a network, other computer systems, and/or any other devices described herein. Wireless communication subsystem 1730 may include a means for transmitting or receiving data, such as identifiers of HMD devices, position data, a geographic map, a heat map, photos, or videos, using antenna(s) 1734 and wireless link(s) 1732.

Embodiments of electronic system 1700 may also include one or more sensors 1790. Sensor(s) 1790 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor.

Electronic system 1700 may include a display module 1760. Display module 1760 may be a near-eye display, and may graphically present information, such as images, videos, and various instructions, from electronic system 1700 to a user. Such information may be derived from one or more application modules 1722-1724, virtual reality engine 1726, one or more other hardware modules 1780, a combination thereof, or any other suitable means for resolving graphical content for the user (e.g., by operating system 1725). Display module 1760 may use LCD technology, LED technology (including, for example, OLED, ILED, μ-LED, AMOLED, TOLED, etc.), light emitting polymer display (LPD) technology, or some other display technology.

Electronic system 1700 may include a user input/output module 1770. User input/output module 1770 may allow a user to send action requests to electronic system 1700. An action request may be a request to perform a particular action. For example, an action request may be to start or end an application or to perform a particular action within the application. User input/output module 1770 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1700. In some embodiments, user input/output module 1770 may provide haptic feedback to the user in accordance with instructions received from electronic system 1700. For example, the haptic feedback may be provided when an action request is received or has been performed.

Electronic system 1700 may include a camera 1750 that may be used to take photos or videos of a user, for example, for tracking the user's eye position. Camera 1750 may also be used to take photos or videos of the environment, for example, for VR, AR, or MR applications. Camera 1750 may include, for example, a complementary metal-oxide-semiconductor (CMOS) image sensor with a few millions or tens of millions of pixels. In some implementations, camera 1750 may include two or more cameras that may be used to capture 3-D images.

In some embodiments, electronic system 1700 may include a plurality of other hardware modules 1780. Each of other hardware modules 1780 may be a physical module within electronic system 1700. While each of other hardware modules 1780 may be permanently configured as a structure, some of other hardware modules 1780 may be temporarily configured to perform specific functions or temporarily activated. Examples of other hardware modules 1780 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 1780 may be implemented in software.

In some embodiments, memory 1720 of electronic system 1700 may also store a virtual reality engine 1726. Virtual reality engine 1726 may execute applications within electronic system 1700 and receive position information, acceleration information, velocity information, predicted future positions, or any combination thereof of the HMD device from the various sensors. In some embodiments, the information received by virtual reality engine 1726 may be used for producing a signal (e.g., display instructions) to display module 1760. For example, if the received information indicates that the user has looked to the left, virtual reality engine 1726 may generate content for the HMD device that mirrors the user's movement in a virtual environment. Additionally, virtual reality engine 1726 may perform an action within an application in response to an action request received from user input/output module 1770 and provide feedback to the user. The provided feedback may be visual, audible, or haptic feedback. In some implementations, processor(s) 1710 may include one or more GPUs that may execute virtual reality engine 1726.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

1. A low dropout (LDO) voltage regulator for a differential signal transmitter driver, the LDO voltage regulator comprising:
a set of pass transistors between a voltage input and a voltage output of the LDO voltage regulator, the set of pass transistors including a first pass transistor and a second pass transistor; and
a control circuit configured to receive data to be transmitted by the differential signal transmitter driver and generate control signals to gates of the set of pass transistors based on the data to be transmitted by the differential signal transmitter driver, the data to be transmitted by the differential signal transmitter driver including data to be transmitted by a first end of the differential signal transmitter driver and data to be transmitted by a second end of the differential signal transmitter driver, the control circuit including:
a first circuit configured to generate a first control signal to a gate of the first pass transistor based on the data to be transmitted by the first end of the differential signal transmitter driver; and
a second circuit configured to generate a second control signal to a gate of the second pass transistor based on the data to be transmitted by the second end of the differential signal transmitter driver.

2. (canceled)

3. The LDO voltage regulator of claim 1, wherein the set of pass transistors includes two or more p-channel metal-oxide-semiconductor (PMOS) transistors.

4. The LDO voltage regulator of claim 1, wherein the control signals include a delayed and inverted copy of the received data to be transmitted by the differential signal transmitter driver.

5. The LDO voltage regulator of claim 1, further comprising a bypass capacitor at the voltage output of the LDO voltage regulator.

6. The LDO voltage regulator of claim 5, wherein a capacitance of the bypass capacitor is equal to or less than 100 pF.

7. The LDO voltage regulator of claim 1, further comprising:
an array of pass transistors between the voltage input and the voltage output of the LDO voltage regulator;
a feedback circuit configured to generate a feedback voltage based on an output voltage of the LDO voltage regulator;
a comparator configured to generate a counter control signal based on the feedback voltage and a reference voltage signal; and
a counter configured to count up or down in response to the counter control signal and output control bits to gates of the array of pass transistors based on a counter value of the counter.

8. The LDO voltage regulator of claim 1, wherein the data to be transmitted by the differential signal transmitter driver includes a phase modulated data pattern.

9. The LDO voltage regulator of claim 1, wherein a data rate of the data to be transmitted by the differential signal transmitter driver is greater than 1 Gbps.

10. An integrated circuit comprising:
a data transmitter driver configured to transmit differential signals; and
a low dropout (LDO) voltage regulator for the data transmitter driver, the LDO voltage regulator comprising:
a set of pass transistors between a voltage input and a voltage output of the LDO voltage regulator, the set of pass transistors including a first pass transistor and a second pass transistor; and
a control circuit configured to receive data to be transmitted by the data transmitter driver and generate control signals to gates of the set of pass transistors based on the data to be transmitted by the data transmitter driver, the data to be transmitted by the data transmitter driver including data to be transmitted by a first end of the data transmitter driver and data to be transmitted by a second end of the data transmitter driver, the control circuit including:
a first circuit configured to generate a first control signal to a gate of the first pass transistor based on the data to be transmitted by the first end of the data transmitter driver; and
a second circuit configured to generate a second control signal to a gate of the second pass transistor based on the data to be transmitted by the second end of the data transmitter driver.

11. The integrated circuit of claim 10, wherein the set of pass transistors includes two or more p-channel metal-oxide-semiconductor (PMOS) transistors.

12. (canceled)

13. The integrated circuit of claim 10, wherein the control signals include a delayed and inverted copy of the received data to be transmitted by the data transmitter driver.

14. The integrated circuit of claim 10, further comprising a bypass capacitor at the voltage output of the LDO voltage regulator.

15. The integrated circuit of claim 14, wherein a capacitance of the bypass capacitor is equal to or less than 100 pF.

16. The integrated circuit of claim 10, wherein the data to be transmitted by the data transmitter driver includes a phase modulated data pattern.

17. The integrated circuit of claim 10, wherein a data rate of the data to be transmitted by the data transmitter driver is greater than 1 Gbps.

18. The integrated circuit of claim 10, wherein the LDO voltage regulator further comprises:
an array of pass transistors between the voltage input and the voltage output of the LDO voltage regulator;
a feedback circuit configured to generate a feedback voltage based on an output voltage of the LDO voltage regulator;
a comparator configured to generate a counter control signal based on the feedback voltage and a reference voltage signal; and
a counter configured to count up or down in response to the counter control signal and output control bits to gates of the array of pass transistors based on a counter value of the counter.

19. A method of reducing noise of an output voltage of a low dropout (LDO) voltage regulator for a differential signal transmitter driver, the method comprising:
receiving data to be transmitted by the differential signal transmitter driver;
generating, using the data to be transmitted by the differential signal transmitter driver, control signals for controlling a set of pass transistors between a voltage input and a voltage output of the LDO voltage regulator, wherein:
the set of pass transistors includes a first pass transistor and a second pass transistor;
the data to be transmitted by the differential signal transmitter driver includes data to be transmitted by a first end of the differential signal transmitter driver and data to be transmitted by a second end of the differential signal transmitter driver; and
generating the control signals includes:
generating a first control signal to drive a gate of the first pass transistor based on the data to be transmitted by the first end of the differential signal transmitter driver; and
generating a second control signal to drive a gate of the second pass transistor based on the data to be transmitted by the second end of the differential signal transmitter driver; and
sending the control signals to gates of the set of pass transistors.

20. (canceled)

21. The method of claim 19, wherein:
the first control signal at the gate of the first pass transistor is aligned with the data to be transmitted by the first end of the differential signal transmitter driver at an input of the first end of the differential signal transmitter driver; and
the second control signal at the gate of the second pass transistor is aligned with the data to be transmitted by the second end of the differential signal transmitter driver at an input of the second end of the differential signal transmitter driver.

22. The LDO voltage regulator of claim 1, wherein:
the first control signal at the gate of the first pass transistor is aligned with the data to be transmitted by the first end of the differential signal transmitter driver at an input of the first end of the differential signal transmitter driver; and
the second control signal at the gate of the second pass transistor is aligned with the data to be transmitted by the second end of the differential signal transmitter driver at an input of the second end of the differential signal transmitter driver.

23. The integrated circuit of claim 10, wherein:
the first control signal at the gate of the first pass transistor is aligned with the data to be transmitted by the first end of the data transmitter driver at an input of the first end of the data transmitter driver; and
the second control signal at the gate of the second pass transistor is aligned with the data to be transmitted by the second end of the data transmitter driver at an input of the second end of the data transmitter driver.
